(19) United States
(12) Patent Application Publication
(10) Pub. No.: US 2025/0027910 A1
(43) Pub. Date: Jan. 23, 2025

(54) CHROMATOGRAPH APPARATUS

(71) Applicant: SHIMADZU CORPORATION, Kyoto (JP)

(72) Inventor: Minoru NAMIKAWA, Kyoto (JP)

(73) Assignee: SHIMADZU CORPORATION, Kyoto (JP)

(21) Appl. No.: 18/765,234

(22) Filed: Jul. 6, 2024

(30) Foreign Application Priority Data
Jul. 19, 2023 (JP) 2023-117668

(51) Int. Cl. G01N 30/14; B01D 15/12; B01D 15/14; G01N 30/02; G01N 30/72

(52) U.S. Cl. CPC G01N 30/14; B01D 15/12; B01D 15/14; G01N 30/7233; G01N 2030/027

(57) ABSTRACT

A sample container (172) holding a sample and a preparative separation container (173) for containing a target component obtained from the sample by preparative separation can be arranged in a preparative separation device (17). A preparative-separation-and-analysis conditions setter (42) allows users to set a preparative separation condition for the target component and an analysis condition for the target component after the preparative separation. A preparative separation executer (43) collects a sample from the sample container, separates the target component contained in the sample, and puts the separated target component into the preparative separation container according to the preparative separation condition after the preparative separation condition and the analysis condition are set. An analysis executer (44) collects the target component from the preparative separation container and performs an analysis of the target component according to the analysis condition, after the preparative separation of the target component.

### TECHNICAL FIELD

The present invention relates to a chromatograph apparatus.

### BACKGROUND ART

One type of liquid chromatograph is a preparative liquid chromatograph (for example, see Patent Literature 1). In a preparative liquid chromatograph, a liquid sample is introduced into a column in the liquid chromatograph, and a target component contained in the liquid sample is separated from the other components by the column, for putting only the target component into a preparative separation container. For the preparative separation of a target component from a sample, it is often the case that the liquid sample is injected into a mobile phase supplied at a high flow rate and introduced into a short column in order to perform the preparative separation of the target component within a short period of time.

Preparative liquid chromatographs are used, for example, in the development of a new drug in the field of drug discovery for the preparative separation of a target component having a medicinal effect. For the checking of the medicinal effect of the target component, a detailed analysis is performed to confirm that the separated target component is the correct component and that no impurities are mixed in the separated target component. In this case, after the target component has been collected in a preparative separation container, an analysis of the target component is performed under detailed analysis conditions specified for that target component.

The analysis conditions for the detailed analysis of the target component are set so that the degree of separation of the components is increased by securing a longer separation time than in the preparative separation, e.g., by setting a lower flow rate of the mobile phase than in the preparative separation of the target component and/or by using a longer column than in the preparative separation.

### CITATION LIST

### Patent Literature

Patent Literature 1: WO 2018/163276 A

### SUMMARY OF INVENTION

### Technical Problem

The conventional method requires a considerable amount of time and labor for the preparative separation and analysis of a target component in a sample: The user needs to set the condition for the preparative separation of the target component before conducting the preparative separation of the target component. When a detailed analysis of a target component in a sample is to be performed, the user needs to check a preparative separation result screen for specific items of information, such as an identification number of the preparative separation container in which the target component has been collected. Furthermore, the user needs to set detailed analysis conditions for the target component before conducting the analysis of the target component.

Although the description thus far has been concerned with the preparative separation and analysis of a target component using a liquid chromatograph, there is also a similar problem in the case of using other types of chromatograph apparatuses, such as a gas chromatograph.

The problem to be solved by the present invention is to reduce the time and labor for performing the preparative separation of a target component in a sample and an analysis of the separated target component by using a chromatograph apparatus.

### Solution to Problem

A chromatograph apparatus according to the present invention developed for solving the previously described problem includes:
a preparative separation device in which a sample container holding a sample containing a target component and a preparative separation container for containing a target component obtained by preparative separation are to be arranged;
a preparative-separation-and-analysis conditions setter configured to allow a user to set a preparative separation condition for the target component and an analysis condition for the target component after the preparative separation;
a preparative separation executer configured to collect a sample from the sample container, separate the target component contained in the sample, and put the separated target component into the preparative separation container according to the preparative separation condition after the preparative separation condition and the analysis condition are set in the preparative-separation-and-analysis conditions setter; and
an analysis executer configured to collect the target component from the preparative separation container and perform an analysis of the target component according to the analysis condition, after the preparative separation of the target component by the preparative separation executer.

### Advantageous Effects of Invention

In the chromatograph apparatus according to the present invention, the preparative-separation-and-analysis conditions setter initially allows the user to set the preparative separation condition and the analysis condition for a target component. Subsequently, the preparative separation executer and the analysis executer continuously perform the preparative separation of the target component contained in the sample and the analysis of the separated target component. Therefore, after the preparative separation of the target component in the sample, the user does not need to check a preparative separation result screen for specific items of information, such as an identification number of the preparative separation container in which the target component has been collected. As a result, the time and labor for the preparative separation and analysis of the target component can be significantly reduced.

### BRIEF DESCRIPTION OF DRAWINGS

FIG. 1 is a diagram showing the configuration of the main components of a preparative liquid chromatograph system as one embodiment of the chromatograph apparatus according to the present invention.

FIG. 2 is a flowchart illustrating the procedure for performing the preparative separation and an analysis of a target component in a sample by the preparative liquid chromatograph system according to the present embodiment.

FIG. 3 is an example of a preparative-separation-and-analysis conditions setting screen in the preparative liquid chromatograph system according to the present embodiment.

FIG. 4 is an example of a result display screen in the preparative liquid chromatograph system according to the present embodiment.

FIG. 5 is a diagram illustrating a method for determining the target vial of a detailed analysis when the target component has been collected in a plurality of vials in the preparative liquid chromatograph system according to the present embodiment.

### DESCRIPTION OF EMBODIMENTS

One embodiment of the chromatograph apparatus according to the present invention is hereinafter described with reference to the drawings. The chromatograph apparatus according to the present embodiment is a preparative liquid chromatograph system having the function of performing the preparative separation of a target component contained in a sample and additionally performing a detailed analysis of the separated target component.

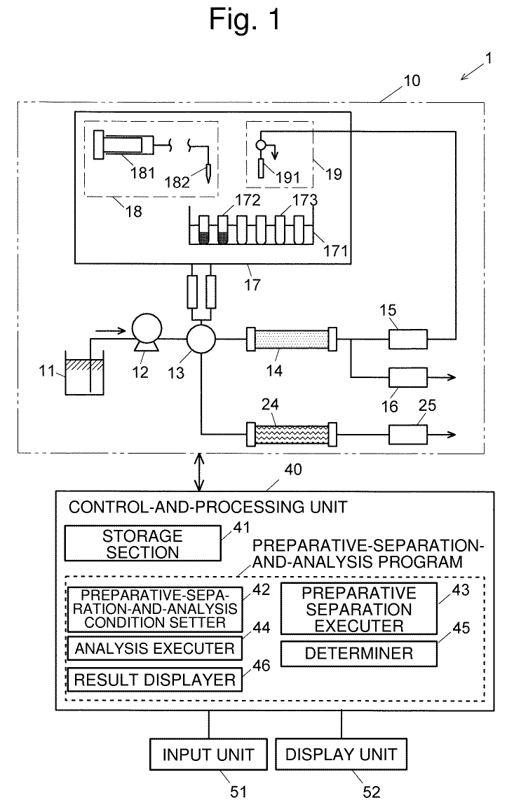

FIG. 1 shows the configuration of the main components of the preparative liquid chromatograph system 1 according to the present embodiment. The preparative liquid chromatograph system 1 includes a preparative liquid chromatograph 10 and a control-and-processing unit 40.

The preparative liquid chromatograph 10 includes a mobile phase container 11, liquid supply pump 12, injector 13, preparative separation column 14, first detector 15, second detector 16, liquid handler 17, analysis column 24, and third detector 25. Although one mobile phase container 11 and one liquid supply pump 12 are schematically shown in FIG. 1, it is also possible to provide a plurality of mobile phase containers 11 which separately hold a plurality of mobile phases and a plurality of liquid supply pumps 12 for separately supplying those mobile phases, as well as a mixer for mixing the supplied mobile phases. The injector 13 has an injection port for a sample for preparative separation and an injection port for a sample for analysis. The two ports introduce a sample for preparative separation into the preparative separation column 14 and a sample for analysis into the analysis column 24, respectively. The first detector 15 is a detector for a non-destructive measurement of components coming from the preparative separation column 14. For example, an absorption spectrometer can be used for this purpose. The second detector 16 is a detector configured to perform a measurement of components coming from the preparative separation column 14 by a method different from the method used in the first detector 15. For example, a mass spectrometer can be used for this purpose. The third detector 25 is a detector for a measurement of components coming from the analysis column 24. Any appropriate type of detector can be used for this purpose.

The liquid handler 17 functions as both an injector for injecting a sample into the mobile phase and a fraction collector for collecting a desired fraction of a liquid coming from the preparative separation column 14 and putting that fraction into a preparative separation container. Within the liquid handler 17, a plate (sample rack) 171 is set, with sample vials 172 holding samples and preparative separation vials 173 for containing separated target components placed thereon. The liquid handler 17 also includes an injection unit 18 having a needle 182 to be inserted into a sample vial 172 and a syringe pump 181 for collecting and ejecting a sample through the needle 182, as well as a preparative separation unit 19 having a nozzle 191 to be inserted into a preparative separation vial 173. The injection unit 18, under the control of a preparative separation executer 43 or an analysis executer 44 (which will be described later), collects a sample or a target component contained in a specified sample vial 172 and injects it into the injector 13. The preparative separation unit 19 puts the target component in the sample into a preparative separation vial 173 based on a condition where the target component has been detected by the first detector 15 and/or the second detector 16. The liquid handler 17 corresponds to the preparative separation device in the present invention.

The sample vials 172 correspond to the sample container, while the preparative separation vials 173 correspond to the preparative separation container.

The control-and-processing unit 40 includes a storage section 41. The storage section 41 holds a method file which contains, for each of a large number of known components, descriptions of information concerning the condition for the preparative separation of the component as well as the condition for a detailed analysis to be performed after the preparative separation of the component. Examples of the preparative separation condition and the analysis condition include: the kind and flow rate of the mobile phase; the type of preparative separation column 14 and that of the analysis column 24; information concerning the detection signal of the component concerned (reference detection signal) in the first detector 15 (e.g., the absorption wavelength and the absorbance in the case where the first detector 15 is an absorption detector); information concerning the detection signal of the component concerned (reference detection signal) in the second detector 16 (e.g., the mass-to-charge ratio and the intensity of an ion in the case where the second detector 16 is a mass spectrometer); and information concerning the detection signal of the component concerned (reference detection signal) in the third detector 25. In the analysis condition, the condition setting is made in order to provide a higher degree of separation than in the preparative separation of the target component, for example, by decreasing the flow rate of the mobile phase and/or using the analysis column 24 which is longer than the preparative separation column 14.

The control-and-processing unit 40 includes, as its functional blocks, a preparative-separation-and-analysis conditions setter 42, preparative separation executer 43, analysis executer 44, determiner 45, and result displayer 46. For example, the control-and-processing unit 40 may actually be a common personal computer, with the aforementioned functional blocks embodied by executing, on a processor in the computer, a pre-installed dedicated program for preparative separation and analysis. An input unit 51 including a keyboard, mouse and other devices, as well as a display unit 52 including a liquid crystal display and other devices are connected to the control-and-processing unit 40.

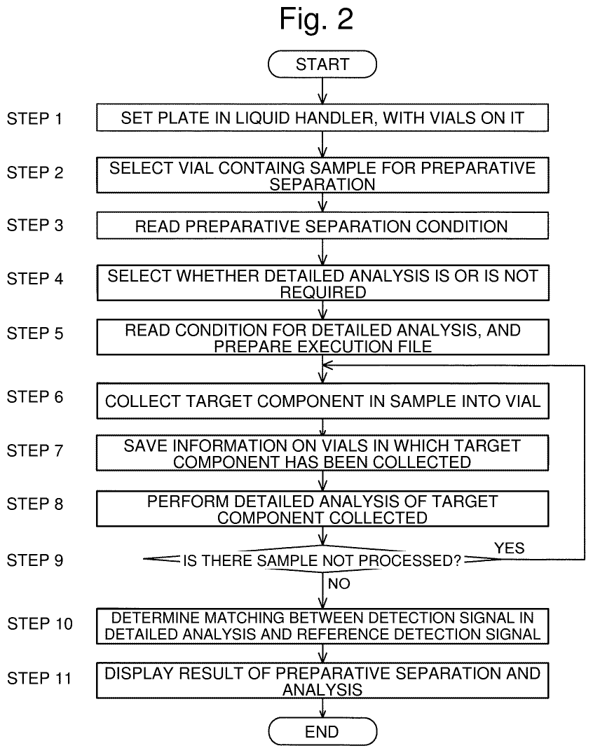

A procedure for the preparative separation and analysis of a target component contained in a sample by using the preparative liquid chromatograph system 1 according to the present embodiment is hereinafter described with reference to the flowchart in FIG. 2.

The user initially places sample vials 172 each of which holds a sample containing a target component, and preparative separation vials 173 for receiving separated target components, at their respective positions on the plate 171 and sets this plate 171 in the liquid handler 17 (Step 1). Subsequently, the user registers information concerning the sample vials 172 and the preparative separation vials 173. If there are multiple plates 171 set in the liquid handler 17, the identification number of each plate 171 should also be registered. For the present embodiment, a single plate 171 having 24 holes (vial placement portions, numbered 1-24) is used. Three sample vials 172 which respectively hold three samples, and 21 preparative separation vials 173 which are empty, are placed on the plate 171 and set in the liquid handler 17. In the present example, the sample vials 172 holding samples are placed at positions numbered 1-3, and the empty preparative separation vials 173 are placed at positions numbered 4-24. The sample vials 172 and the preparative separation vials 173 may be placed on separate plates.

The user subsequently issues a command to initiate the setting of the preparative separation condition. Then, the preparative-separation-and-analysis conditions setter 42 displays, on the display unit 52, a screen for allowing the user to set the preparative separation condition for each target component contained in each sample as well as the condition for the detailed analysis of each target component after the preparative separation.

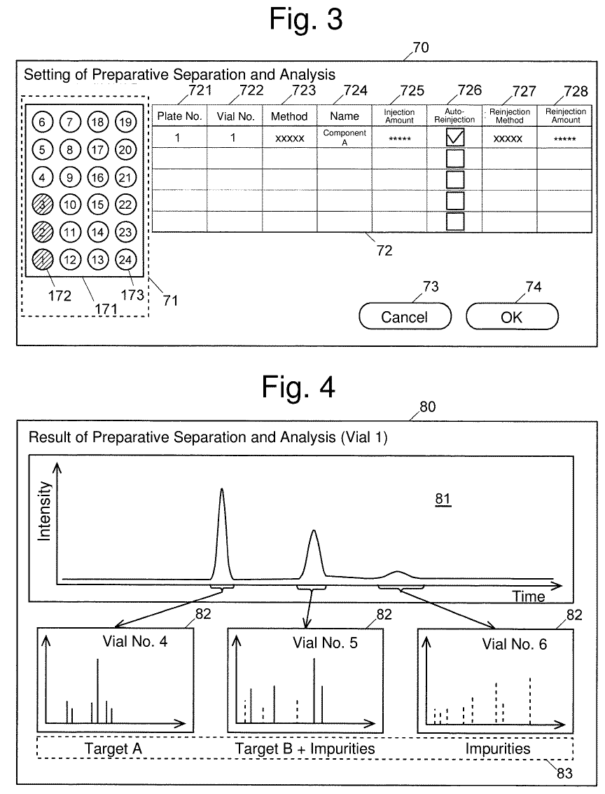

FIG. 3 is an example of a screen for setting the preparative separation condition and the analysis condition. On this preparative-separation-and-analysis conditions setting screen 70, a vial display area 71, preparative-separation-and-analysis conditions display area 72, cancel button 73 and OK button 74 are shown. The preparative-separation-and-analysis conditions display area 72 has a plate No. field 721, vial No. field 722, method field 723, name field 724, injection amount field 725, auto-reinjection field 726, reinjection method field 727, and reinjection amount field 728. In this manner, the present embodiment is configured so that the plate No. field 721, vial No. field 722, method field 723, name field 724, injection amount field 725, auto-reinjection field 726, reinjection method field 727, and reinjection amount field 728 are displayed on the same screen, thereby allowing the user to set the preparative separation condition and the analysis condition on the same screen. This improves the user-friendliness of the system.

The vial display area 71 shows a top view of the plate 171 set in the liquid handler 17. Only one plate 171 is set in the present example. When there are multiple plates 171 set in the liquid handler 17, those plates 171 can be displayed in a switchable manner or next to each other. In the vial display area 71, the sample vials 172 holding samples and the empty preparative separation vials 173 are shown in a distinguishable manner based on the information previously registered by the user. In the example of FIG. 3, the sample vials 173 numbered 1-3 among the vials held in the 24-hole plate 171 are shaded to indicate that samples are contained in those vials. In place of the shading, a different form of display, such as a colored display, may also be used to enable visual distinction between the sample vials 172 holding samples and the empty preparative separation vials 173.

From the shaded sample vials 172 (which hold samples) shown in the vial display area 71, the user selects, by using a mouse (or the similar operation), a vial which holds a sample from which the preparative separation of the target component should be performed (Step 2). When the operation for selecting a sample vial 172 in the vial display area 71 has been performed by the user, the identification number of the plate 171 on which the selected sample vial 172 is placed, and the serial number (position) of the vial on that plate 171, are automatically entered into the plate No. field 721 and the vial No. field 722 of the preparative-separation-and-analysis conditions display area 72, respectively.

Next, the user reads, from the storage section 41, a method file which describes the condition for the preparative separation of the target component from the sample contained in the selected sample vial 172. The filename of the method file read by the user is shown in the method field 723 of the preparative-separation-and-analysis conditions display area 72 (Step 3). Additionally, the name of the target component to be separated by the execution of the method file is read into the name field 724 of the preparative-separation-and-analysis conditions display area 72. In the case of performing the preparative separation of a plurality of target components by a single method, the names of those target components will be shown in the name field 724. The user also inputs the amount of injection of the sample in the injection amount field 725. As opposed to the present example in which the user manually inputs the injection amount, this value may be previously set in the preparative separation condition described in the method file so that the injection amount can be automatically read and entered into the injection amount field 725.

The user subsequently selects whether a detailed analysis on the target component separated from the sample should or should not be automatically performed (Step 4). This selection is made by checking the box in the auto-reinjection field 726.

When the box in the auto-reinjection field 726 has been checked, the preparative-separation-and-analysis conditions setter 42 enables the reinjection method field 727 to receive an input. The user reads, from the storage section 41, a method file which describes the condition of the detailed analysis for the separated target component. The filename of the method file read by the user is shown in the reinjection method field 727 of the preparative-separation-and-analysis conditions display area 72. The user also inputs the amount of injection of the target component for the detailed analysis in the reinjection amount field 728. Once again, as opposed to the present example in which the user manually inputs the injection amount, this value may be previously set in the analysis condition described in the method file so that the amount injection can be automatically read and entered into the reinjection amount field 728.

After completing the previously described inputting task for all samples for which the preparative separation and detailed analysis of the target components are to be performed, the user presses the OK button 74. Then, the preparative-separation-and-analysis conditions setter 42 reads each sample selected by the user, the preparative separation condition for the preparative separation of each target component from that sample, and the condition for the detailed analysis of the separated target component and prepares a file for continuously performing those operations (Step 5). The user can reset the already entered preparative-separation-and-analysis conditions by pressing the cancel button 73. In the case of a sample for which the auto-reinjection field 726 has not been checked, the preparative-separation-and-analysis conditions setter 42 prepares an execution file for performing only the preparative separation of the target component. In the case of a sample for which the auto-reinjection field 726 has been checked, the preparative-separation-and-analysis conditions setter 42 prepares an execution file for initially performing the preparative separation of the target component, followed by automatic reinjection of the separated target component to perform the detailed analysis.

After the preparative-separation-and-analysis execution files have been prepared, the user performs a predetermined input operation for issuing a command to initiate the preparative separation and analysis of the target components. Then, the preparative separation executer 43 controls the related sections of the preparative liquid chromatograph 10 to collect a sample from the first sample vial 172 on the first plate 171 selected by the user in the preparative-separation-and-analysis conditions display area 72. The target component contained in the sample is separated from the other components while passing through the preparative separation column 14, and ultimately exits the same column 14. Based on a condition where the exiting target component has been detected by the first detector 15 and/or the second detector 16, the preparative separation unit 19 collects the target component into a preparative separation vial 173 (Step 6).

The preparative separation unit 19 sequentially puts the target components into the empty preparative separation vials 173 in ascending order of their serial numbers. In the present embodiment, since the sample vials numbered 1-3 already hold samples, the target components are sequentially put into the subsequent preparative separation vials 173 starting from vial number 4. The amount of separated component to be put into one preparative separation vial 173 is previously determined. If the sample liquid containing the target component exiting the preparative separation column 14 exceeds that amount, the preparative separation unit 19 changes the destination of the separated target component from the current preparative separation vial 173 to the next vial 173, number 5. After the target component has been collected by the preparative separation unit 19, the preparative separation executer 43 records, in the storage section 41, the information of the preparative separation vial 173 in which the target component has been collected (plate number and vial number) along with the sample name, target component name, as well as the detection signal of the first detector 15 and that of the second detector 16 at the time of the collection (Step 7).

In the case of a sample for which an execution file for performing only the preparative separation of the target component has been prepared, only the preparative separation of the target component contained in that sample is performed. In the case of a sample for which an execution file for performing the preparative separation of the target component and the subsequent detailed analysis of the separated target component has been prepared, the analysis executer 44 subsequently operates the related sections of the preparative liquid chromatograph 10 to perform the detailed analysis of the separated target component, using the analysis column 24 and the third detector 25, based on the conditions described in the execution file (Step 8).

When the preparative separation and the detailed analysis (if the execution of the detailed analysis is set) of the target component for the first sample have been completed, the preparative separation executer 43 determines whether there exists a sample that has not yet been processed (Step 9). If there is a sample which has not yet been processed (YES in Step 9), the operation returns to Step 5 to perform the preparative separation and the detailed analysis of the target component for that sample which has not yet been processed. If all samples have been processed and no sample remains to be processed (NO in Step 9), the entire sequence of operations for the preparative separation and the detailed analysis of the target components is completed.

After the preparative separation and the detailed analysis of the target component have been completed for all samples, the determiner 45 makes a judgment on the result of the detailed analysis for each of the target components for which the detailed analysis has been performed. Specifically, for example, the detection signal of the third detector 25 (e.g., an absorption spectrum or mass spectrum) acquired in the detailed analysis of the target component is compared with a reference detection signal (e.g., an absorption spectrum or mass spectrum) of the same target component stored in the storage section 41, to determine whether the two signals match each other within a previously specified permissible range (Step 10). If the two signals have been judged to match each other, the determiner 45 concludes that the collected substance is the target component, with no impurities mixed. If the two signals have not been judged to match each other, the determiner 45 tests whether the detection signal of the third detector 25 (e.g., an absorption spectrum or mass spectrum) acquired in the detailed analysis includes the detection signal (e.g., an absorption spectrum or mass spectrum) of the same target component stored in the storage section 41. If the detection signal of the same target component stored in the storage section 41 is included in the former signal, the determiner 45 concludes that the collected substance contains the target component and impurities. If the detection signal of the same target component stored in the storage section 41 is not included, the determiner 45 concludes that the collected substance is not the target component. Specifically, for example, if a mass peak which is present in the standard mass spectrum and a mass peak which is not present in the standard mass spectrum have been located in a mass spectrum created from the detection signal of the third detector 25, it is concluded that the collected substance contains the target component and an impurity.

After the judgment by the determiner 45 has been completed for all target components for which the detailed analysis has been performed, the result displayer 46 shows the preparative separation and analysis results on the screen of the display unit 52, including the detection signals acquired with the first and second detectors 15 and 16 in the preparative separation of the target component from each sample, the detection signal acquired with the third detector 25 in the detailed analysis of the separated target component, as well as the results of the judgment by the determiner 45 (Step 11).

FIG. 4 shows one example of a result display screen 80 shown by the result displayer 46. This example of the result display screen 80 shows a case in which target components A and B contained in a sample were separately collected and subjected to a detailed analysis. The result display screen 80 shows a total ion current chromatogram (TICC) 81 acquired in the preparative separation of target components A and B, mass spectra 82 each of which was acquired in the detailed analysis of a substance collected at a position corresponding to a peak on the TICC 81, and a determination result 83 related to each collected substance. Each mass spectrum 82 is labelled with the serial number of the preparative separation vial 173 in which the collected substance concerned is contained. In each mass spectrum 82, the solid lines indicate mass peaks at the mass-to-charge ratios which have been judged to match the mass peaks in the standard mass spectrum by the determiner 45 in the judgment process (i.e., the mass peaks of the target component), while the broken lines indicate mass peaks which have not been judged to match (i.e., the mass peaks of impurities). The results of the judgment by the determiner 45 are shown below the corresponding mass spectra 82. By checking those pieces of information on the result display screen 80, the user can visually understand whether a collected substance is a target component, and whether an impurity is contained in that collected substance.

Conventionally, a considerable amount of time and labor has been required for the preparative separation and analysis of a target component in a sample: The user needs to set the condition for the preparative separation of the target component before conducting the preparative separation of the target component. When a detailed analysis of a target component in a sample is to be performed, the user needs to check a preparative separation result screen for specific items of information, such as an identification number of the preparative separation container in which the target component has been collected. Furthermore, the user needs to set detailed analysis conditions for the target component before conducting the analysis of the target component.

In the preparative liquid chromatograph system 1 according to the present embodiment, the preparative-separation-and-analysis conditions setter 42 initially allows the user to set the preparative separation condition and the analysis condition for a target component. Subsequently, the preparative separation executer 43 and the analysis executer 44 continuously perform the preparative separation of the target component contained in the sample and the analysis of the separated target component. Therefore, after the preparative separation of the target component in the sample, the user does not need to check a preparative separation result screen for specific items of information, such as an identification number of the preparative separation container in which the target component has been collected. As a result, the time and labor for the preparative separation and analysis of the target component can be significantly reduced.

As noted earlier, the amount of target component to be collected in one preparative separation vial 173 is previously specified. When the amount of sample liquid containing the target component exceeds that specified amount, the target component will be collected into a plurality of preparative separation vials 173. A detailed analysis could be performed for all of those preparative separation vials 173. However, to improve the efficiency of the analysis, it is preferable to perform the detailed analysis on the target component collected in only one of the preparative separation vials 173 since the substances collected in those preparative separation vials 173 are basically identical.

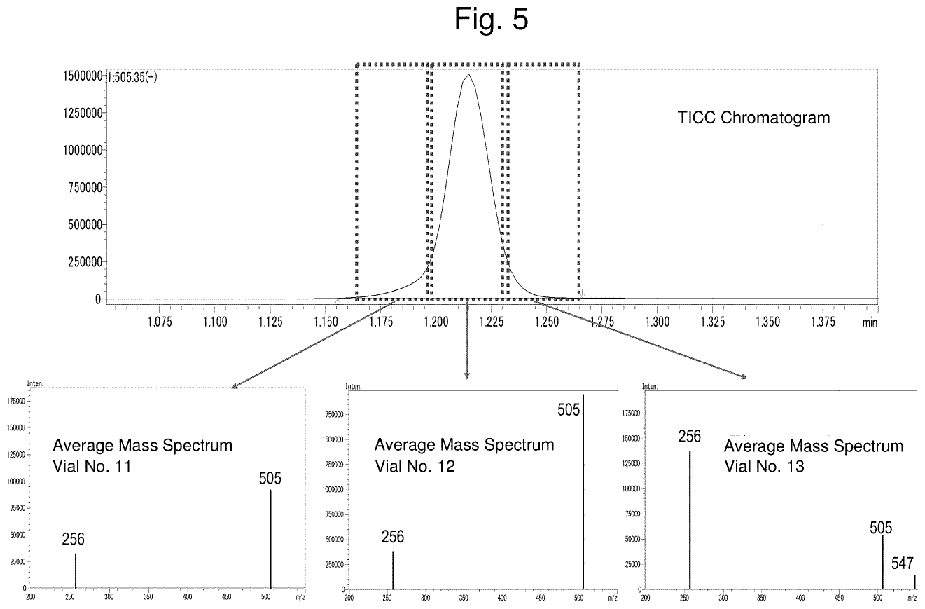

The following description illustrates the procedure for determining the preparative separation vial 173 for which the detailed analysis should be performed in the case where a sample liquid which exited from the preparative separation column 14 in a temporally continuous manner has been collected in a plurality of preparative separation vials 173. Referring to FIG. 5, the following description deals with a specific example in which the second detector 16 is a mass spectrometer and mass spectrum data acquired with this mass spectrometer is used as the basis for determining the preparative separation vial 173 for which the detailed analysis should be performed. FIG. 5 is the case where a sample liquid which exited from the preparative separation column 14 in a temporally continuous manner has been collected in three preparative separation vials 173 (numbered 11-13).

The analysis executer 44 reads mass spectrum data acquired by repeatedly performing an MS scan measurement using the second detector 16 within a period of time during which the sample liquid that exited in a temporally continuous manner was collected over a plurality of preparative separation vials 173. Then, the analysis executer 44 calculates an average mass spectrum for each preparative separation vial 173 from a plurality of sets of mass spectrum data acquired within that period of time during which the target component was collected into that vial (lower section in FIG. 5). As opposed to the present example in which an MS scan measurement is performed to acquire mass spectra, three selected ion monitoring (SIM) measurements may be repeatedly performed in place of the MS scan measurement, one for a target ion originating from target component A, one for a target ion originating from target component B and one for a non-target ion. If the periods of time during which target components A and B exit from the preparative separation column 14 (retention times) are previously known, it is possible to perform SIM measurements for the target ion of target component A and a non-target ion during the retention time of target component A, as well as SIM measurements for the target ion of target component B and a non-target ion during the retention time of target component B.

The analysis executer 44 subsequently calculates, for each of the three preparative separation vials 173 (numbered 11-13), the intensity of a mass peak at the mass-to-charge ratio of a target ion which is a representative ion originating from the target component as well as the intensity of a mass peak at the mass-to-charge ratio of a non-target ion which originates from a non-target component and is detected with a substantially constant intensity independent of time. The value of the mass-to-charge ratio of the target ion is previously stored for each target component in the storage section 41, while that of the mass-to-charge ratio of the non-target ion is previously stored for each preparative separation condition. For example, the mass-to-charge ratio of the non-target ion may be the mass-to-charge ratio of an ion generated from the mobile phase which constantly flows into the detector regardless of time. In the example of FIG. 5, the mass-to-charge ratio of the target ion is 505, while that of the non-target ion is 256. The intensity of a mass peak is calculated from the area value or height of the mass peak.

Subsequently, for each of the three preparative separation vials 173 (numbered 11-13), the analysis executer 44 calculates the ratio of the intensity of the mass peak of the target ion to that of the non-target ion. The vial 173 having the highest ratio is designated as a candidate from which the target component should be collected in the detailed analysis. The sample in the preparative separation vial 173 designated as the candidate may ultimately be subjected to a detailed analysis using the reinjection method and the amount of reinjection previously set before the beginning of the preparative separation. In the present example, the preparative separation vial 173 numbered 12 is designated as the candidate from which the target component should be collected in the detailed analysis.

The analysis executer 44 also determines whether the intensity of the mass peak of the target ion related to the candidate vial exceeds a previously determined threshold. This threshold can be previously set as one item of the analysis condition and saved in the storage section 41. If the intensity of the mass peak of the target ion related to the candidate vial exceeds the threshold, the vial designated as the candidate is ultimately designated as the vial from which the target component should be collected in the detailed analysis.

The previously described process of designating the vial from which the target component should be collected in the detailed analysis makes it unnecessary to perform the detailed analysis for each of the vials in which the same target component has been collected, so that the efficiency of the detailed analysis is improved. By selecting the vial having the highest ratio of the intensity of the mass peak of the target ion to that of the non-target ion, the detailed analysis can be performed using the target component collected from the vial containing a larger amount of target component. Furthermore, since the target of the detailed analysis is limited to a vial with the intensity of the mass peak of the target ion exceeding the threshold, the consumption of a target component which has been collected in small quantity in the preparative separation can be reduced. For a target component which has been collected in small quantity in the preparative separation, the detailed analysis can be performed by using a different method which can be performed even with a small amount of target component.

The previous embodiment is a mere example and can be appropriately changed or modified without departing from the spirit of the present invention. In the previous embodiment, the requirement that the intensity of the mass peak of the target ion to be subjected to the detailed analysis should exceed the threshold is applied in the case where the same target component has been collected in a plurality of vials. The requirement that the intensity of the mass peak of the target ion should exceed the threshold may similarly be included in the conditions for the detailed analysis of a target component collected in a single vial. This further reduces the amount of consumption of a target component which has been collected in small quantity in the preparative separation.

In the previous embodiment, the ratio of the intensity of the mass peak of the target ion to that of the non-target ion is calculated for each vial, and a vial having the highest ratio is designated as the candidate from which the target component should be collected in the detailed analysis. When there is no ion appropriate as the non-target ion, a vial having the highest intensity of the mass peak of the target ion may be designated as the candidate from which the target component should be collected in the detailed analysis. In the previous embodiment, mass peaks appearing in a mass spectrum are used as an example of the detection signal for determining the candidate from which the target component should be collected in the detailed analysis. An appropriate kind of detection signal depending on the type of detector may be used for this purpose.

Although the previous embodiment is a preparative liquid chromatograph system 1, the previously described configuration can similarly be adopted in a system including a gas chromatograph in place of the liquid chromatograph.

### MODES

It is evident to a person skilled in the art that the previously described illustrative embodiments are specific examples of the following modes of the present invention.

### Clause 1

A chromatograph apparatus according to one mode of the present invention includes:
a preparative separation device in which a sample container holding a sample containing a target component and a preparative separation container for containing a target component obtained by preparative separation are to be arranged;
a preparative-separation-and-analysis conditions setter configured to allow a user to set a preparative separation condition for the target component and an analysis condition for the target component after the preparative separation;
a preparative separation executer configured to collect a sample from the sample container, separate the target component contained in the sample, and put the separated target component into the preparative separation container according to the preparative separation condition after the preparative separation condition and the analysis condition are set in the preparative-separation-and-analysis conditions setter; and
an analysis executer configured to collect the target component from the preparative separation container and perform an analysis of the target component according to the analysis condition, after the preparative separation of the target component by the preparative separation executer.

In the chromatograph apparatus according to Clause 1, the preparative-separation-and-analysis conditions setter initially allows the user to set the preparative separation condition and the analysis condition for a target component. Subsequently, the preparative separation executer and the analysis executer continuously perform the preparative separation of the target component contained in the sample and the analysis of the separated target component. Therefore, after the preparative separation of the target component in the sample, the user does not need to check a preparative separation result screen for specific items of information, such as an identification number of the preparative separation container in which the target component has been collected. As a result, the time and labor for the preparative separation and analysis of the target component can be significantly reduced.

### Clause 2

In the chromatograph apparatus according to Clause 2, which is one mode of the chromatograph apparatus according to Clause 1,
the preparative-separation-and-analysis conditions setter is further configured to allow the user to specify whether an analysis of the target component should be performed after the preparative separation of the target component; and
the analysis executer is configured to perform the analysis of the target component following the preparative separation of the target component if the execution of the analysis of the target component is specified by the user.

The chromatograph apparatus according to Clause 2 can selectively perform a detailed analysis for only a target component which the user considers requires a detailed analysis.

### Clause 3

In the chromatograph apparatus according to Clause 3, which is one mode of the chromatograph apparatus according to Clause 1 or 2, the analysis executer is configured to perform an analysis of the target component based on a condition where a detection signal acquired in the preparative separation of the target component satisfies a previously determined criterion.

For example, the “previously determined criterion” may be the requirement that the magnitude of the detection signal acquired in the preparative separation of the target component should exceed a previously determined threshold. The chromatograph apparatus according to Clause 3 performs a detailed analysis for the target component only when a sufficient amount of target component satisfying a predetermined criterion was collected in the preparative separation. Therefore, when the amount of target component collected in the preparative separation is low, the additional consumption of the target component by the detailed analysis can be avoided.

### Clause 4

In the chromatograph apparatus according to Clause 4, which is one mode of the chromatograph apparatus according to one of Clauses 1-3, the analysis executer is configured so that, when the preparative separation executer collected a target component into a plurality of preparative separation containers in a temporally continuous manner, the analysis executer performs an analysis for only a target component contained in one preparative separation container among the plurality of preparative separation containers.

The amount of liquid that can be collected in one preparative separation container is specified beforehand. Therefore, if the amount of target component exceeds that amount, the same target component will be collected in a plurality of preparative separation containers in a temporally continuous manner. In the chromatograph apparatus according to Clause 4, the preparative separation container which contains the largest amount of target component is located among those preparative separation containers, and the detailed analysis is performed only for the target component contained in that preparative separation container. Therefore, the analysis efficiency will be improved as compared to the case of performing the detailed analysis for all fractions of the same target component collected in a plurality of preparative separation containers.

### Clause 5

In the chromatograph apparatus according to Clause 5, which is one mode of the chromatograph apparatus according to Clause 4, the analysis executer is configured to perform an analysis for only a target component contained in one preparative separation container corresponding to a period of time during which the detection signal acquired for the target component had the largest magnitude among the plurality of preparative separation containers.

In the chromatograph apparatus according to Clause 5, the detailed analysis is performed for the target component collected from one preparative separation container holding the largest fraction of the target component among the plurality of comparative container. Therefore, the detailed analysis can be more accurately performed.

### Clause 6

In the chromatograph apparatus according to Clause 6, which is one mode of the chromatograph apparatus according to Clause 5, the detection signal is an intensity of an ion generated from the target component, measured with a mass spectrometer, and the analysis executer is configured to perform an analysis only for the target component contained in one preparative separation container having the highest ratio of the measured intensity of an ion generated from the target component, to the intensity of an ion generated, regardless of time, from a previously determined component different from the target component.

The chromatograph apparatus according to Clause 6 uses a measurement signal acquired with a mass spectrometer which can accurately discriminate between compounds. Therefore, the preparative separation container which holds the largest fraction of the target component can be identified with a high level of accuracy.

### Clause 7

In the chromatograph apparatus according to Clause 7, which is one mode of the chromatograph apparatus according to one of Clauses 1-6, the preparative-separation-and-analysis conditions setter is configured to allow the user to set the preparative separation condition and the analysis condition on the same screen.

The chromatograph apparatus according to Clause 7 allows the user to set the preparative separation condition and the analysis condition on the same screen. This improves the user-friendliness of the apparatus.

### REFERENCE SIGNS LIST

1 . . . Preparative Liquid Chromatograph System
10 . . . Preparative Liquid Chromatograph
11 . . . Mobile Phase Container
12 . . . Liquid Supply Pump
13 . . . Injector
14 . . . Preparative Separation Column
15 . . . First Detector
16 . . . Second Detector
17 . . . Liquid Handler
171 . . . Plate
172 . . . Vial Containing Sample
173 . . . Vial for Containing Target Component
18 . . . Injection Unit
181 . . . Syringe Pump
182 . . . Needle
19 . . . Preparative Separation Unit
191 . . . Nozzle
24 . . . Analysis Column
25 . . . Third Detector
40 . . . Control-and-Processing Unit
41 . . . Storage Section
42 . . . Preparative-Separation-and-Analysis Conditions Setter
43 . . . Preparative Separation Executer
44 . . . Analysis Executer
45 . . . Determiner
46 . . . Result Displayer
51 . . . Input Unit
52 . . . Display Unit
70 . . . Preparative-Separation-and-Analysis Conditions Setting Screen
71 . . . Vial Display Area
72 . . . Preparative-Separation-and-Analysis Conditions Display Area
721 . . . Plate No. field
722 . . . Vial No. field
723 . . . Method Field
724 . . . Name Field
725 . . . Injection Amount Field
726 . . . Auto-Reinjection Field
727 . . . Reinjection Method Field
728 . . . Reinjection Amount Field
73 . . . Cancel Button
74 . . . OK Button
80 . . . Result Display Screen
81 . . . Total Ion Current Chromatogram
82 . . . Mass Spectrum
83 . . . Determination Result

1. A chromatograph apparatus, comprising:
a preparative separation device in which a sample container holding a sample containing a target component and a preparative separation container for containing a target component obtained by preparative separation are to be arranged;
a preparative-separation-and-analysis conditions setter configured to allow a user to set a preparative separation condition for the target component and an analysis condition for the target component after the preparative separation;
a preparative separation executer configured to collect a sample from the sample container, separate the target component contained in the sample, and put the separated target component into the preparative separation container according to the preparative separation condition after the preparative separation condition and the analysis condition are set in the preparative-separation-and-analysis conditions setter; and
an analysis executer configured to collect the target component from the preparative separation container and perform an analysis of the target component according to the analysis condition, after the preparative separation of the target component by the preparative separation executer.

2. The chromatograph apparatus according to claim 1, wherein:
the preparative-separation-and-analysis conditions setter is further configured to allow the user to specify whether an analysis of the target component should be performed after the preparative separation of the target component; and
the analysis executer is configured to perform the analysis of the target component following the preparative separation of the target component if an execution of the analysis of the target component is specified by the user.

3. The chromatograph apparatus according to claim 1, wherein the analysis executer is configured to perform an analysis of the target component based on a condition where a detection signal acquired in the preparative separation of the target component satisfies a previously determined criterion.

4. The chromatograph apparatus according to claim 1, wherein the analysis executer is configured so that, when the preparative separation executer collected a target component into a plurality of preparative separation containers in a temporally continuous manner, the analysis executer performs an analysis for only a target component contained in one preparative separation container among the plurality of preparative separation containers.

5. The chromatograph apparatus according to claim 4, wherein the analysis executer is configured to perform an analysis for only a target component contained in one preparative separation container corresponding to a period of time during which a detection signal acquired for the target component had a largest magnitude among the plurality of preparative separation containers.

6. The chromatograph apparatus according to claim 5, wherein the detection signal is an intensity of an ion generated from the target component, measured with a mass spectrometer, and the analysis executer is configured to perform an analysis only for the target component contained in one preparative separation container having a highest ratio of the measured intensity of the ion generated from the target component, to the intensity of an ion generated, regardless of time, from a previously determined component different from the target component.

7. The chromatograph apparatus according to claim 1, wherein the preparative-separation-and-analysis conditions setter is configured to allow the user to set the preparative separation condition and the analysis condition on a same screen.
